(19) United States
(12) Patent Application Publication
(10) Pub. No.: US 2026/0155278 A1
(43) Pub. Date: Jun. 4, 2026

(54) RADIOFREQUENCY (RF) CIRCUIT MEDIA INTERFACES AND CORRESPONDING SYSTEMS AND METHODS

(71) Applicant: Mellanox Technologies, Ltd., Yokneam (IL)

(72) Inventors: Rotem Glick CARMI, Kiryat Motzkin (IL); Elad MENTOVICH, Tel Aviv (IL); Ella SANDERS, HaSolelim (IL); Ran Hasson RUSO, Pardes Hanna-Karkur (IL); Kosta MOGILEVSKY, Haifa (IL); Timothy DE KEULENAER, Ghent (BE); Marijn VERBEKE, Ghent (BE)

(21) Appl. No.: 19/050,408

(22) Filed: Feb. 11, 2025

Related U.S. Application Data
(60) Provisional application No. 63/727,747, filed on Dec. 4, 2024.

(51) Int. Cl. H01B 5/14

(52) U.S. Cl. CPC H01B 5/14

(57) ABSTRACT

An interface structure includes an interface between a first conductive medium and a second conductive medium; and an electrically conductive coating in electrical communication with both the first conductive medium and the second conductive medium across the interface. In an example embodiment, the presence of the electrically conductive coating improves the signal integrity at the interface compared to when the electrically conductive coating is not present. Various embodiments provide methods for fabricating interface structures.

### CROSS-REFERENCE TO RELATED APPLICATION(S)

This application claims priority to U.S. Application No. 63/727,747, filed Dec. 4, 2024, the content of which is incorporated herein by reference in its entirety.

### BACKGROUND

The present disclosure relates to the field of electronic circuits and their micro-architecture, and more particularly to electronic interconnects.

Datacenters and other networking systems may include connections between switch systems, servers, racks, and devices in order to provide for signal transmission between one or more of these elements. These connections may be made using cables, transceivers, and connector assemblies that utilize optical, electrical (e.g., copper), and/or similar transmission mediums. Due to the large number of connections in these environments, copper cabling may be used for connections over short distances (e.g., in order to minimize cost).

Demands on RF systems are on the rise. Modern systems are called upon to support higher data rates over tightening bandwidth. Furthermore, the proliferation of RF devices has led to demand for support across multiple frequency bands. New bands of the frequency spectrum are continually released to meet capacity demands. Each of these factors has led to increased power consumption in RF transmitters, and specifically, increased power demands and decreased efficiency in power amplifiers.

As demands have grown, so too has RF technology. For example, the evolution of 3G, 4G, and long term evolution (LTE) communication networks have led to significant increases in RF signal dynamic range and increased peak power to accommodate higher data rates and more complex modulation schemes. The availability of varieties of channel coding and modulation techniques, the demand for broader channel bandwidths, and high peak-to-average power ratio (PAPR) modulation schemes all press their demands on power availability and efficiency.

The electrical conduits used to conduct RF signals may not include a single continuous conductor. For example, the electrical conduits may include interfaces such as direct attached copper cable (DAC), solder joints between a bulk copper conductor and a conductive pad of a printed circuit board (PCB), and/or the like. Signal integrity is reduced by reflections at such interfaces. In high-speed communication systems, impedance matching is crucial to maintain signal integrity. However, junctions or interfaces between two conductive media (such as the copper conductor and the pad) are subjected to impedance mismatch which causes reflections and other signal integrity issues, particularly where the surface is a significant reflection area.

In a technical feasibility of passive copper cables at 200Gbps/lane (Noujeim et al. 2021, IEEE 802.3 Beyond 400G Ethernet Study Group), a cable assembly was found to have a significant contribution to the insertion loss (22-28% of total insertion loss). This insertion loss is generally due to losses at interfaces such as solder joints of copper conductive on pads and possibly additional bonds.

### GENERAL DESCRIPTION

Attempts to address issues caused by signal reflection at interfaces focus on impedance matching by optimal choice of materials, mainly for the intermetallic compound (IMC), and on the design of the solder joint itself, such as specific bonding methods. For example, connector design and precision manufacturing processes (with high accuracy, repeatability, and tight tolerances) are used to ensure proper impedance matching and effective shielding. Gold or other high-quality plating is often used to prevent corrosion and maintain conductivity. Another existing technique that is used in DAC manufacturing involves covering the solder joint with an insulating material such as UV-glue, typically applied by a dispenser for a precise placement. This method can be used for chemical resistance and mechanical protection.

However, these solutions have a limited effectiveness due to inherent discontinuities between the different materials and require further implementation of advanced signal conditioning techniques (such as equalization and pre-emphasis) to compensate for signal distortions.

One aspect of the present disclosure provides an interface structure comprising: an interface between conductive media having different characteristic impedances; and an electrically conductive coating placed over the interface, wherein the electrically conductive coating is configured to improve signal integrity at the interface.

One aspect of the present disclosure provides a method of improving signal integrity (SI) at an interface between conductive media having different characteristic impedances. The method comprises placing an electrically conductive coating over the interface, wherein the electrically conductive coating is configured to improve signal integrity at the interface. In some embodiments, the technique is applicable to any packaging system in which a structure is used to facilitate an electrical connection between two adjacent package substrates.

According to one aspect of the present disclosure, an interface structure is provided. In an example embodiment, the interface structure includes an interface between a first conductive medium and a second conductive medium; and an electrically conductive coating in electrical communication with both the first conductive medium and the second conductive medium across the interface.

In an example embodiment, the first conductive medium and the second conductive medium have different characteristic impedances. In an example embodiment, the electrically conductive coating is configured to create a continuous conductive surface over the interface. In an example embodiment, the electrically conductive coating is configured to reduce the impedance mismatch across an interface between the first conductive medium and the second conductive medium. In an example embodiment, the electrically conductive coating comprises graphene. In an example embodiment, the electrically conductive coating is between one atomic layer and 100 μm thick. In an example embodiment, the interface includes a mechanical interface or a solder joint. In an example embodiment, the interface is a solder joint and includes a soldering material in additional to the first conductive medium and the second conductive medium and the electrically conductive coating is in electrical communication with each of the first conductive medium, the second conductive medium, and the soldering material.

In an example embodiment, the interface includes at least one of: a conductive wire, a flyover cable, a conductive pad of a printed circuit board (PCB), a conductive pad on a die, a wire bond, a solder bump connection, a via interface, or an interface between vias to a ball grid array (BGA). For example, the first conductive medium and/or second conductive medium may be a conductive wire, a flyover cable, a conductive pad of a printed circuit board (PCB), a conductive pad on a die, a wire bond, a solder bump connection, a via interface, or an interface between vias to a ball grid array (BGA).

According to another aspect of the present disclosure, a method for fabricating an interface structure is provided. In an example embodiment, the method includes applying an electrically conductive coating to an interface between a first conductive medium and a second conductive medium such that the electrically conductive coating is in electrical communication with both the first conductive medium and the second conductive medium across the interface.

In an example embodiment, applying the electrically conductive coating to the interface comprises creating a continuous conductive surface across the interface. In an example embodiment, the first conductive medium and the second conductive medium have different characteristic impedances. In an example embodiment, the electrically conductive coating is configured to reduce the impedance mismatch across the interface between the first conductive medium and the second conductive medium. In an example embodiment, the interface comprises a solder joint or a mechanical interface between the first conductive medium and the second conductive medium. In an example embodiment, applying the electrically conductive coating to the interface comprises forming a two-dimensional (2D) or three-dimensional (3D) coating made of a conductive material that reduces signal reflections across the interface. In an example embodiment, applying of the electrically conductive coating to the interface is carried out by at least one of: spraying, sputtering, dipping, brushing, dipping, dispensing, printing, or application through a mask.

In an example embodiment, the method further includes designing the electrically conductive coating to improve signal integrity by attenuating signals passing through the interface. In an example embodiment, the method further includes determining an amplification or conditioning to be applied to the signals to be conducted across the interface based at least in part on attenuation of the signals passing through the interface by the electrically conductive coating.

In an example embodiment, the method further includes identifying one or more interfaces in a circuit design that are prone to SI reduction in a circuit design, wherein the interface between the first conductive medium and the second conductive medium is one of the one or more interfaces. In an example embodiment, respective electrically conductive coatings are applied to each of the one or more interfaces such that the electrically conductive coatings do not short-circuit one or more circuits comprising the one or more interfaces.

These, additional, and/or other aspects and/or advantages of the present disclosure are set forth in the detailed description which follows, possibly inferable from the detailed description, and/or learnable by practice of the present disclosure.

### BRIEF DESCRIPTION OF THE DRAWINGS

For a better understanding of embodiments of the disclosure and to show how the same may be carried into effect, reference will now be made, purely by way of example, to the accompanying drawings in which like numerals designate corresponding elements or sections throughout. In the accompanying drawings:

FIGS. 1A-1D are high-level schematic illustrations of interface structures, according to some embodiments of the disclosure; and

FIGS. 2A-2B are high-level flowcharts illustrating methods, according to some embodiments of the disclosure.

FIGS. 3A-3C provide simulation results that indicate the expected effect of disclosed coatings, according to some embodiments of the disclosure.

FIG. 4 illustrates an example computer system that may include electrical components, according to at least one embodiment.

FIG. 5 provides a block diagram that schematically illustrates a computing system that may include one or more electrical components of various embodiments.

FIG. 6 illustrates an example computing environment that may include electrical components, in accordance with at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DISCLOSURE

In the following description, various aspects of the present disclosure are described. For purposes of explanation, specific configurations and details are set forth in order to provide a thorough understanding of the present disclosure. However, it will also be apparent to one skilled in the art that the present disclosure may be practiced without the specific details presented herein. Furthermore, well-known features may have been omitted or simplified in order not to obscure the present disclosure. With specific reference to the drawings, it is stressed that the particulars shown are by way of example and for purposes of illustrative discussion of the present disclosure only, and are presented in the cause of providing what is believed to be the most useful and readily understood description of the principles and conceptual aspects of the disclosure. In this regard, no attempt is made to show structural details of the disclosure in more detail than is necessary for a fundamental understanding of the disclosure, the description taken with the drawings making apparent to those skilled in the art how the several forms of the disclosure may be embodied in practice.

Before at least one embodiment of the disclosure is explained in detail, it is to be understood that the disclosure is not limited in its application to the details of construction and the arrangement of the components set forth in the following description or illustrated in the drawings. The disclosure is applicable to other embodiments that may be practiced or carried out in various ways as well as to combinations of the disclosed embodiments. Also, it is to be understood that the phraseology and terminology employed herein are for the purpose of description and should not be regarded as limiting.

Some embodiments of the present disclosure provide efficient and economical methods and mechanisms for improving signal integrity (SI) at an interface between conductive media having different characteristic impedances, and thereby provide improvements to the technological field of electronic circuits and their micro-architecture. Interface structures and methods of improving the SI at the interface between conductive media having different characteristic impedances are provided.

The interface is formed by a connection between at least two conductive media (wire soldered on a printed circuit board (PCB) pad, bonded wire on a pad, flip-chipped die on a substrate, flyover cables etc.) which may be at least partially covered by an electrically conductive layer. Disclosed embodiments may be applied to interfaces (e.g., in high-speed conducting lines) that transmit various types of signals, including RF (radio frequency) signals, including modulated RF signals (having frequencies in a range of 3 kHz to 300 GHz) for communications applications (100 MHz to 300 GHz).

An electrically conductive coating is placed over the interface between the conductive media, to improve the SI affected by the interface, e.g., by creating a continuous conductive surface over the interface and/or by overcoming the differences in impedances between the conductive media. The coating may include graphene in various forms such as the following non-limiting examples: composite material layer of graphene particles or flakes in a polymeric or other matrix, multi layers of flakes (with any value of twist angle between layers) and/or single layer graphene (e.g., an atomic layer).

The geometry of the coatings may be configured and optimized according to the type and structure of the respective interface that is to be coated and according to manufacturability considerations. For example, the coating may be applied to form a round shape (optimal for manufacturability), a rectangular shape (for a good fit with pads on the board) or a customized shape in case of special features or height differences that should be coated.

Area of coverage should include all the media/phases/material type that are part of the target interface. In case it is not possible to cover them all, it should cover at least 20% of each medium that is part of the interface to create a continuous layer. Electrical shorts should be avoided.

The coating enhances the signal integrity of the signal going through the interface, e.g., by reducing reflections of the signal and reduces the error rates for the signal, especially for high frequency signals. It is noted that even though the coating may add some noise, the signal quality is still improved, and conditioning techniques can be efficiently implemented to further reduce the error rates. Advantageously, the improvements in signal integrity are achieved due to graphene's effective electrical conductivity, which is significantly higher compared to metals, specifically at high frequencies. Additional criteria that make the graphene suitable for the SI improvement include its weight, flexibility, and chemical resistance.

In conventional RF circuits, the SI of a signal conducted through the circuit is degraded at interfaces between conductive components of the circuit (e.g., wire soldered on a PCB pad, bonded wire on a pad, flip-chipped die on a substrate, flyover cables etc.). For example, a signal may suffer insertion loss as a result of interfaces of the circuit. Conventional techniques for preventing such SI degradation and/or insertion loss include impedance matching at interfaces between conductive components. However, this is not easy to accomplish at a variety of interfaces and/or difficult to achieve across a wide range of signal frequencies. Therefore, technical problems exist regarding SI degradation and insertion loss at interfaces between electrical components of electrical circuits.

Various embodiments provide technical solution to these technical problems. Various embodiments provide interface structures and methods for fabricating such interface structures. The interface structures include an electrically conductive coating disposed on and/or across and interface between a first conductive medium and a second conductive medium such that the electrically conductive coating, first conductive medium and second conductive medium are all in electrical communication with one another. For example, the electrically conductive coating is configured to create a continuous conductive surface over the interface. In various embodiments, the electrically conductive coating is configured to reduce the impedance mismatch across an interface between the first conductive medium and the second conductive medium. Thus, even though the first conductive medium and the second conductive medium may have different characteristic impedances, the signal may still be efficiently conducted across the interface with a reduced degradation of the SI and/or reduced signal loss (compared to if the electrically conductive coating was not present).

Various embodiments therefore provide improvements to the fields of RF circuits, circuits configured for conducting RF signals and systems including such circuits.

### Example Interface Structures

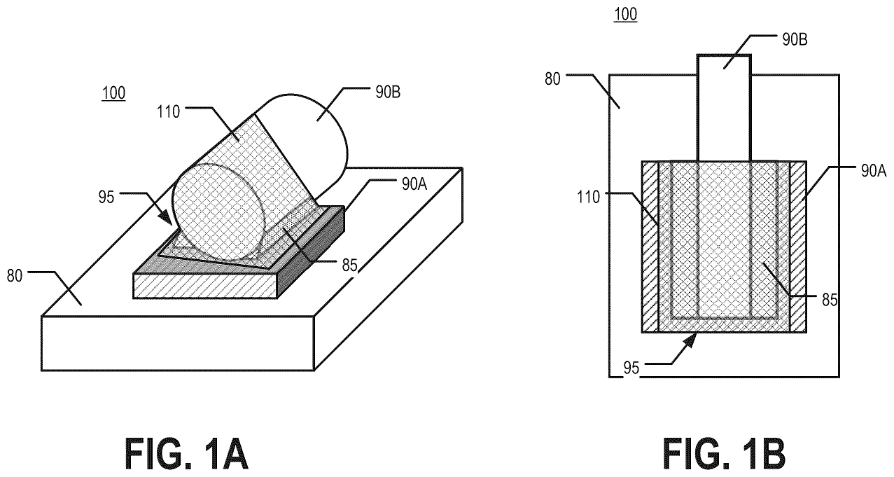

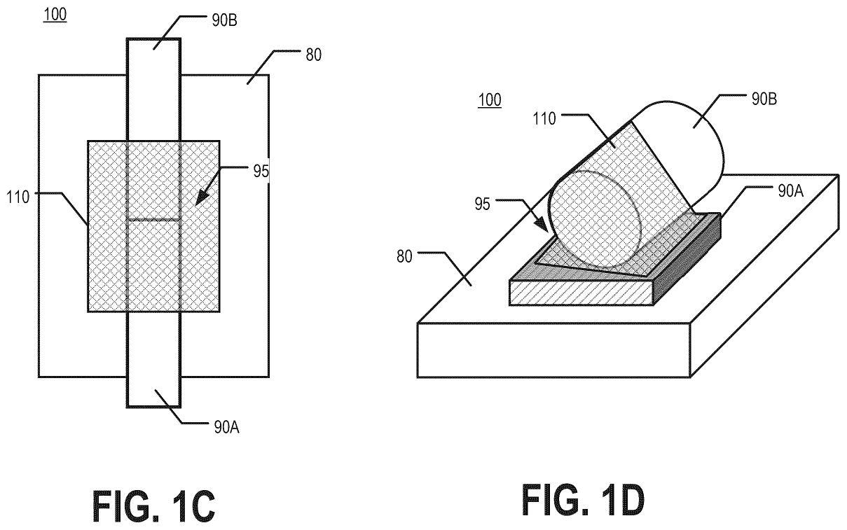

FIGS. 1A-1D are high-level schematic illustrations of example interface structures 100, according to some embodiments of the disclosure. FIG. 1A is a schematic perspective view of an interface structure including a solder joint and FIG. 1B provides a top view of the interface structure shown in FIG. 1A. For example, FIGS. 1A and 1B illustrate an interface structure 100 where the first conductive medium 90A is a conductive pad on a substrate 80 and the second conductive medium 90B is a wire or cable soldered to the conductive pad via soldering material 85. FIG. 1C provides a top view of an example interface structure where the first conductive medium 90A and the second conductive medium 90B are mechanically connected (e.g., formed on or secured to the substrate 80 such that they are in physical contact with one another). FIG. 1D is a schematic perspective view of another interface structure including two conductive media that are mechanically connected where the first conductive medium 90A is a conductive pad on the substrate 80 and the second conductive medium 90B is a wired mechanically connected into electrical communication with the conductive pad. In various embodiments, the first conductive medium 90A and the second conductive medium 90B are secured into mechanically connection with one another by bonding, welding, crimping, applying pressure, or another mechanical method of connection.

In various embodiments, an interface structure 100 comprises an interface 95 between a first conductive medium 90A and a second conductive medium 90B. An interface structure 100 further includes an electrically conductive coating 110 in electrical communication with both the first conductive medium 90A and the second conductive medium 90B across the interface 95. In various embodiments, the presence of the electrically conductive coating 110 improves the SI of an RF signal conducted through the interface 95 (compared to when the electrically conductive coating 110 is not present). For example, the degradation of the SI of an RF signal conducted through the interface 95 is reduced as a result of the presence of the electrically conductive coating 110. It is noted that the term coating is used in a broad sense to include any type of full or partial covering of the electrically conductive components of the interface 95 (e.g., first conductive medium 90A, second conductive medium 90B, and/or soldering material 85), by any means, as long as electrically conductive coating 110 is continuous and connects (e.g., is in electrical communication with) all the participating media. In various embodiments, electrically conductive coating 110 may comprise graphene that is applied on the surface of the interface by spraying, brushing, dipping, or any other method.

In various embodiments, the first conductive medium 90A and the second conductive medium 90B have different characteristic impedances. For example, the first conductive medium 90A is characterized by a first characteristic impedance and the second conductive medium 90B is characterized by a second characteristic impedance. The first characteristic impedance is not equal to the second characteristic impedance. An electrically conductive coating 110 is applied over the interface 95 between the first conductive medium 90A and the second conductive medium 90B to improve signal integrity at interface 95. For example, the electrically conductive coating 110 may be configured to create a continuous conductive surface over interface 95 and to reduce the differences in impedances between the first conductive medium 90A and the second conductive medium 90B and/or across the interface 95.

In various embodiments, the electrically conductive coating 110 comprises a broadband conductive material. Non-limiting examples for the electrically conductive coating 110 materials include graphene in various forms, e.g., single layered (monolayer) graphene, multiple layered graphene (including two or more layers) as well as composite graphene materials (e.g., graphene flakes within a matrix). In some embodiments, carbon nanotubes may be applied, possibly within a matrix, to form the electrically conductive coating 110. The electrically conductive coating 110 may be configured to be conformal with respect to the geometry of the interface, e.g., using flexible graphene coating or graphene flakes within a matrix that is formed conformally over the interface.

Non-limiting examples for electrically conductive coating 110 dimensions include coating thickness between one or a few atomic layers, hundreds of nm, a few μm and up to tens of μm or any intermediate values. For example, the thickness of the electrically conductive coating may be within a range of one atomic layer to 100μm thick. It is noted that the coating thickness is configured to not add any capacitance to the interface, e.g., by preventing the formation of graphite by the coated material.

In various embodiments, the first conductive medium 90A and/or the second conductive medium 90B are and/or comprise a conductive wire, a flyover cable, a conductive pad of a printed circuit board (PCB), a conductive pad on a die, a wire bond, a solder bump connection, a via interface, or an interface between vias to a ball grid array (BGA). In various embodiments, the first conductive medium 90A and/or the second conductive medium 90B are and/or comprise a any type of networking cable (e.g., direct attach copper (DAC), active copper cable (ACC), active optical cables (AOCs), cable assembly (with octal small form factor pluggable (OSFP) connectors or the like) or interconnect utilized by datacenter racks and associated switch modules such as a small form pluggable (SFP), quad small form-factor pluggable (QSFP), or the like). In various embodiments, the first conductive medium 90A and/or the second conductive medium 90B are and/or comprise a passive copper cable (PCC) and an active optical module for transmitting optical signals. In other alternative cases, the first conductive medium 90A and/or the second conductive medium 90B are and/or comprise may also include an Ethernet cable.

In various embodiments, the interface structure 100 is part of a semiconductor device. The semiconductor device may be a pluggable network interface device that may include a network connector (e.g., the male end portion of a DAC assembly). The network connectors may each be configured to connect to a networking device of any type (e.g., QSFP, DAC, AOC, etc.), and may thus be dimensioned (e.g., sized and shaped) to mate with or otherwise connect to any corresponding networking device. The network connector may be of any type (e.g., an AOC connector, Ethernet connector, DAC connector, Active Optical Module, or the like).

In various embodiments, the interface 95 includes multiple conductive media (e.g., first conductive medium 90A and second conductive medium 90B) which may have different characteristic impedances. This typically causes signal reflections and introduces noise into signals (e.g., high frequency radiofrequency, RF, signals) moving through the interface 95. The reflections may be caused due to connection of different materials and the impedance mismatch-adding noise to the signal (especially at high frequencies). The interface 95 between the different materials can be with or without intermediate metal conduit (IMC), depending on the bonding process (solder-based or mechanical connection). Applying the continuous electrically conductive coating 110 over and/or on the interface 95 (e.g., forming a graphene layer in electrical connection with the first conductive medium 90A and the second conductive medium 90B) improves the signal integrity by providing an alternative conduction path to reduce the reflections of the signal. Moreover, applying the electrically conductive coating 110 over the interface 95 may also smoothen the discontinuities or roughness of the connections and thereby also reduce the losses due to the skin-effect (at high frequencies), in addition to the achieved reduction in reflections. A lower resistance may also reduce the thermal noise, which may also contribute to further reduction of the overall noise.

For example, an interface 95 may comprise a solder joint (illustrated schematically in FIGS. 1A and 1B) in which a second conductive medium 90B (e.g., a cable made of copper, for example) is attached to a first conductive medium 90A on a substrate 80 (e.g., a soldering pad on a PCB) (e.g., a soldering pad on a PCB) via soldering material 85 (e.g., tin and lead solder). In the context of the present disclosure, the term “solder” refers to a fusible alloy made from any suitable solder paste, such as SAC305 composition, and the term “solder joint” refers to a stack of elements connected by solder alloy. In the packaging of integrated circuit (IC) chips, an IC chip is typically mounted on a packaging substrate to facilitate electrical connection of the IC chip to a motherboard or other PCB. The connection between the IC chip and the packaging substrate can be a plurality of solder joints, such as reflowed solder balls or solder micro-bumps, which are solder bumps deposited on surface pads of the IC chip. The solder joint may be between the copper conductive (the bulk copper) and the PCB pads and/or the interface between the copper conductive and the folded braid.

In some embodiments, mechanical connections may comprise interface structures 100 without a solder layer, illustrated, e.g., schematically in FIGS. 1C and 1D, with electrically conductive coating 110 placed over interface 95 to improve signal integrity at interface 95.

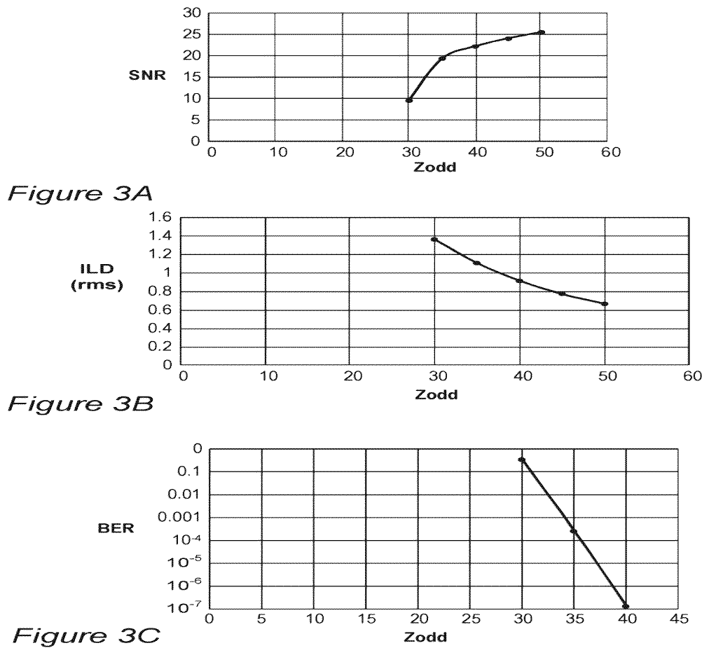

In non-limiting examples, characteristic impedances of solder joints are in the range between 30-150 Ω. For example, in typical implementations, the characteristic impedance may be around 100Ω (Zdiff-differential impedance), or 50Ω (Zodd-odd impedance). In simulation results provided illustrated in FIG. 3As-3C, decreasing Zodd below 50Ω decreases the signal-to-noise ratio (SNR), increases the root mean squared insertion loss deviation (ILD (rms)), and degrades the bit error rate (BER). These values are in correspondence with the IEEE standard 8023-2022: 96.7.1.1 (referring to the characteristic differential impedance as being 100Ω±10% and Guo at al. 2019 (Study of TDR impedance for better analysis to measurement correlation, 2019 Joint International Symposium on Electromagnetic Compatibility, Sapporo and Asia-Pacific International Symposium on Electromagnetic Compatibility (EMC Sapporo/APEMC)), which provide an illustration of TDR (Time Domain Reflectometry) from Zdiff=100Ω to 90-85Ω, which is within 10-15% deviation. For example, reducing the Zodd below 50Ω (i.e., increasing the mismatch between the characteristic impedance (Zodd) and its nominal value of 50Ω) increases the reflections of RF signals at the interface.

It is noted that some interfaces onto which the disclosed methods may be applied, like a wire-bond, cannot be easily characterized as a transmission line with a certain characteristic impedance. For example, a wire-bond is typically modelled as an inductor, for which the impedance is frequency dependent. Typically, matching circuits are designed to match the impedances and reduce reflections. However, this is difficult across a broad frequency range.

Applying the electrically conductive coating 110 onto the interface 95 such that the electrically conductive coating is in electrical communication with the first conductive medium 90A, second conductive medium 90B, and, if present, the soldering material 85, the electrically conductive coating 110 reduces the impedance mismatch across the interface 95. For example, in various embodiments, an interface structure 100 exhibits a reduced impedance mismatch compared to the interface 95 without the electrically conductive coating 110. As a result, the effect of the electrically conductive coating 110 is to improve the SNR, reduce the ILD (rms), and reduce the BER of RF signals conducted through the interface 95 or a broad range of frequencies of RF signals.

The electrically conductive coating 110 may be applied as two-dimensional (2D) or a three-dimensional (3D) coating over interface 95 (e.g., the solder joint), to cover the top and the sides of the surface of the solder joint or other type of interface, and provide an alternative or complementary conductive path for the signal that compensates for possible noise introduced by the interface 95, and reduces the effect of the differences in impedances between the first conductive medium 90A and the second conductive medium 90B.

Non-limiting examples for interfaces 95 onto which electrically conductive coating 110 is applied to form an interface structure 100 in accordance with various embodiments include solder joints, wire bonds and solder bump connections (e.g., as in DAC), wires soldered on PCB pads, bonded wires on pads, flipped-chip die on a substrate, flyover cables, interfaces between various features such as between vias to a ball grid array (BGA), interfaces between features involved in pin through holes (PTHs), surface mount techniques (SMT), and so forth. In various embodiments, the interface structure 100 may be part of a system such as a graphics processing unit (GPU), a central processing unit (CPU), data processing unit (DPU), field-programmable gate array (FPGA), application-specific integrated circuit (ASIC), digital signal processor (DSP), microprocessor chip, or other type of integrated circuit (IC). Various embodiments provide interface structures 100 that may be any interconnect from a PCB to a socket, packaged (or naked-die) IC and the interconnects between a socket and the package and from the package to the IC, optical IC, interposers, optical transceiver modules, flexlines, FPGA, and/or the like.

In various embodiments, electrically conductive coating 110 is applied onto the interface 95 to form an interface structure 100 by various coating techniques such as spraying, sputtering, brushing, dipping, dispensing, printing, application through a mask, chemical and/or physical deposition, or by other application methods. In various embodiments, a mask is used to protect adjacent conductive elements from being short-circuited by the electrically conductive coating 110. For example, protection masks may comprise a layer made of an electrically insulated material that is applied on adjacent conductive elements that should remain uncovered with the highly electrically conductive coating 110. It is noted that as electrically conductive coating 110 is a 2D or 3D coating, the application technique is adjusted accordingly. The electrically conductive coating 110 may be applied onto interface 95 uniformly.

The electrically conductive coating 110 is configured to improve signal integrity at the interface 95 because the electrically conductive coating 110 reduces the noise and/or the insertion loss from interface 95, possibly, by providing an alternative conduction path and/or by attenuating plasmonic effects at the interface 95 and/or by reducing the difference in impedances at the interface. As a result, the presence of the electrically conductive coating 110 improves the signal integrity, especially in high frequency signals (e.g., few to tens of GHz, e.g., between 1-60 GHz). While the electrically conductive coating 110 may attenuate the signals being conducted through the interface 95, the significant reduction of insertion loss and improvement of signal integrity (SI) allow for amplifying or conditioning the signals (e.g., linearly) with a significantly reduced level of noise and/or insertion loss to yield smoother signals (e.g., having a smoother frequency response than more traditional coating materials such as NiCr). In various embodiments, the electrically conductive coating 110 is a graphene coating having a smooth surface, which may also contribute to the reduction of signal reflection compared to the rough interface 95. Furthermore, electrically conductive coating 110 may also enhance the chemical resistance and mechanical protection characteristics of interface structure 100.

For example, an electrically conductive coating 110 (e.g., comprising graphene) applied over interfaces 95 such as solder joints may reduce reflection of signals by creating a continuous conductive film above the interface of different materials (PCB pad, solder material, conductive wire) that may be used as a bypass to minimize the impedance mismatch. While the electrically conductive coating 110 (e.g., comprising graphene) over the solder joints might increase the signal attenuation, the attenuation becomes more linear as a result of the insertion loss being reduced and/or minimized, and thus may be easily corrected using algorithms of advanced signal conditioning techniques.

It is noted that PCBs are used to electrically connect electronic components using conductive pathways, or traces, etched from metal sheets, which may be connected to disclosed interfaces. In many electronic systems, one or more very large-scale integrated circuit (VLSI) components are coupled to a host system PCB. Such VLSI components may include, for example, CPU devices and/or GPU devices. The PCB may hold at least one processing circuitry. The processing circuitry may comprise hardware. For example, the processing circuitry may comprise an ASIC and/or may be capable of performing as a CPU, a GPU, a network interface controller (NIC), a SPU, or any other computing device in which data is received and/or transmitted. Other non-limiting examples of the processing circuitry include an IC chip, a CPU, a GPU, a microprocessor, an FPGA, a collection of logic gates or transistors, resistors, capacitors, inductors, diodes, or the like. It should be appreciated that any appropriate type of electrical or optical component or collection of electrical or optical components may be suitable for inclusion in the processing circuitry. In various embodiments, semiconductor packages may be mounted within a through hole of a PCB. It should be noted that PCBs of various types and/or having various form factors may be used in various embodiments, as appropriate for the application. Persons having skill in the art and having reference to this disclosure will readily appreciate that the same or similar apparatus and techniques may also be employed with PCBs having various types and form factors. For example, in some embodiments, the PCB to which a semiconductor package is mounted (the semiconductor package and/or the PCB including an interface structure 100) may comprise an add-in card, such as a PCIe card, that is configured to be coupled to a system board or motherboard of a host system. In other embodiments, the PCB to which the semiconductor package is mounted may be the system board or motherboard of the host system itself. Moreover, the system board or the motherboard may be associated with any type of host system. For example, the PCB may comprise the system board in a multi-node rack-mounted server in a data center, or it may comprise the motherboard of a workstation, desktop, laptop, or mobile device. Other embodiments are also possible. Disclosed embodiments may be applied to various interfaces 95 of and/or on various types of PCBs.

### Example Method of Fabricating an Interface Structure

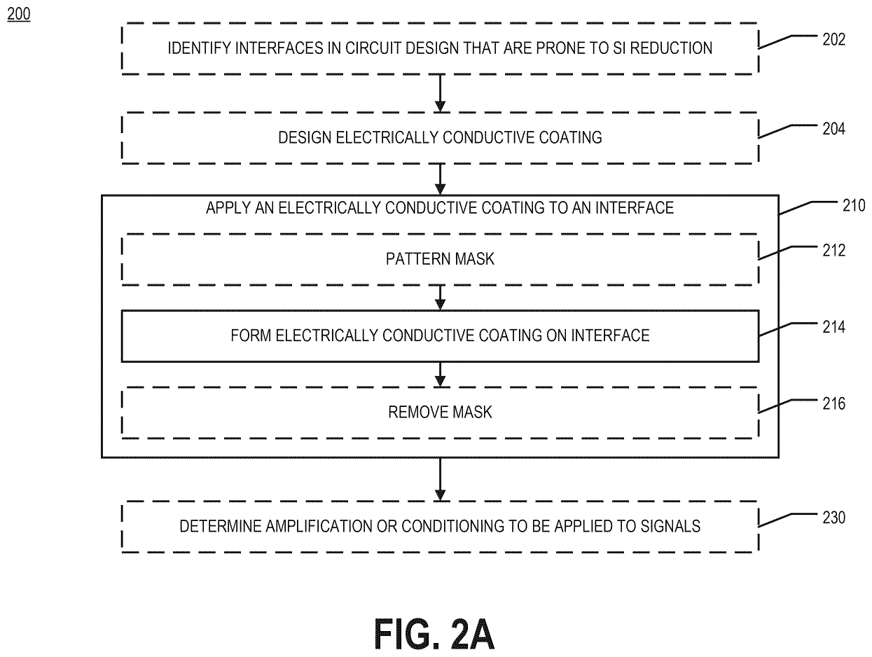

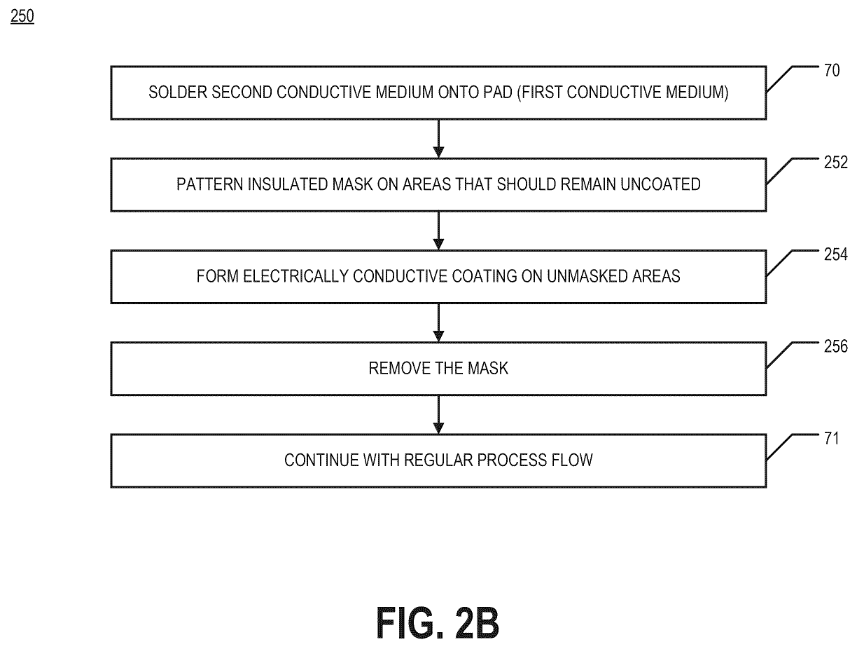

FIGS. 2A and 2B are high-level flowcharts illustrating methods 200 and 250, according to some embodiments of the disclosure. The processes, procedures, and/or operations of methods 200 and/or 250 may be performed to form an interface structure 100 at an interface 95 between a first conductive medium 90A and a second conductive medium 90B. Various processes, procedures, and/or operations of method 200 and/or 250 may be at least partially implemented by at least one computer processor, e.g., in an inspection and/or fabrication system. Certain embodiments comprise computer program products comprising a non-transitory computer readable storage medium having computer readable program embodied therewith and configured to carry out the relevant processes, procedures, and/or operations of method 200 and/or 250.

In various embodiments, an interface structure 100 may be fabricated in accordance with method 200 in order to improve the signal integrity (SI) of RF signals conducted through an interface 95 of an RF circuit. For example, starting at block 202, a circuit design may be analyzed and/or processed to identify one or more interfaces of the circuit design that are prone, likely, and/or anticipated to have SI reduction. For example, a computer program may be executed to process a circuit design to identify interfaces 95 of the circuit design between conductive media of different impedances, that have different frequency-dependent responses to RF signals, and/or that may otherwise be prone to SI reduction.

At block 204, an electrically conductive coating 110 may be designed for each interface 95 (e.g., identified at block 202). In various embodiments, designing the electrically conductive coating 110 may include one or more of determining the coating material to be used to form the electrically conductive coating 110, selecting a coating application technique to be used to form the electrically conductive coating 110, determining and/or selecting a thickness of the electrically conductive coating 110, determining and/or selecting a surface area or a perimeter of the electrically conductive coating 110, and/or determining and/or selecting various other properties of the electrically conductive coating. In various embodiments, one or more properties of the electrically conductive coating 110 are determined and/or selected based at least in part on the circuit design, an expected frequency range of use (e.g., a frequency range of RF signals expected to be conducted through the interface 95), a geometry and/or topology of the interface 95, a type of the interface 95 (e.g., solder joint, mechanical connection, and/or the like), characteristics of the first conductive medium 90A, characteristics of the second conductive medium 90B, characteristics of soldering material 85, and/or the like. The electrically conductive coating 110 is designed such that the electrically conductive coating 110 is configured to not short circuit the RF circuit including the interface 95 or any other circuit at least partially disposed on the substrate 80.

In various embodiments, the electrically conductive coating 110 may be individually designed for a corresponding interface 95. In other words, the electrically conductive coatings 110 of two interface structures 100 of the same RF circuit and/or present on the same PCB, for example, may be designed to have different properties (e.g., the coating material may be different, the coating material may be applied using different techniques, the thickness of the coating material may be different, the surface area of the electrically conductive coatings may be different, and/or the like). In some embodiments, the electrically conductive coating 110 is designed to improve signal integrity by attenuating signals passing through the corresponding interface 95, to allow amplifying and/or conditioning the attenuated signals, for example.

In various embodiments, the electrically conductive coating 110 is designed such that the electrically conductive coating 110 is configured to create a continuous conductive surface over the interface 95. In various embodiments, the electrically conductive coating 110 is designed such that the electrically conductive coating 110 is configured to overcome (or reduce) the differences in impedances between the first conductive medium 90A and the second conductive medium 90B.

At block 210, the electrically conductive coating 110 is applied to the interface 95. For example, the electrically conductive coating 110 may be applied to the interface 95 such that the properties of the electrically conductive coating 110 are in accordance with the design of the electrically conductive coating 110 determined at block 204. For example, the electrically conductive is applied and/or placed on and/or over the interface 95 such that the electrically conductive coating is configured to improve signal integrity at the interface 95. In various embodiments, the electrically conductive coating 110 is applied and/or placed on and/or over the interface 95 so as to avoid and/or prevent the electrically conductive coating 110 from short circuiting the RF circuit including the interface 95 or any other circuit at least partially disposed on the substrate 80. For example, applying the electrically conductive coating 110 to the interface 95 comprises forming a two-dimensional (2D) or three-dimensional (3D) coating made of a conductive material that reduces signal reflections across the interface 95, in various embodiments.

In various embodiments, the interface 95 onto and/or over which the electrically conductive coating 110 is applied and/or placed may comprise any type of mechanical connection between different conductive media, or solder joints (that include an IMC, such as soldering material 85, in an interface between the first conductive medium 90A and the second conductive medium 90B), and placing of the electrically conductive coating over the interface may comprise applying a 2D or 3D coating over the mechanical connection or the solder joint. In various embodiments, the electrically conductive coating 110 comprises a (broadband) conductive material that reduces signal reflections at the interface 95. In various embodiments, the electrically conductive coating 110 is configured to reduce the impedance mismatch across the interface 95 between the first conductive medium 90A and the second conductive medium 90B.

In various embodiments, applying and/or placing the electrically conductive coating 110 on the interface 95 comprises patterning a mask on the substrate 80, at block 212. In some embodiments, the mask comprises an electrically insulating material. In various embodiments, the mask is patterned to form and/or define unmasked areas where respective electrically conductive coatings 110 are to be applied, placed, and/or formed and masked areas where the conductive material of the electrically conductive coating 110 should not be applied.

In various embodiments, applying and/or placing the electrically conductive coating 110 on the interface 95 comprises forming the electrically conductive coating 110 on and/or over the interface 95, at block 214. In various embodiments, the electrically conductive coating 110 is formed by placing the (broadband) electrically conductive material over the interface 95 by spraying, sputtering, dipping, brushing, chemical and/or physical deposition, dispensing, printing, and/or application through a mask. In some embodiments, the electrically conductive coating 110 is formed via 3D printing, which may be used after applying an insulated mask on the conductive areas to avoid shorts, or without applying an insulated mask. In various embodiments, forming the electrically conductive coating 110 on and/or over the interface 95 comprises creating a continuous conductive surface across the interface.

In various embodiments, applying and/or placing the electrically conductive coating 110 on the interface 95 comprises removing the mask, at block 216. For example, if a mask was patterned at block 212, the mask may be removed after the electrically conductive coating 110 has been formed.

At block 230, an amplification and/or conditioning to be applied to signals conducted through the interface 95 and/or the interface structure 100 may be determined. For example, one or more RF signals, possibly of various frequencies, may be conducted through the interface 95 and/or the interface structure 100 and an effect on the RF signal(s) of being conducted though the interface 95 and/or the interface structure 100 may be determined. An amplification and/or conditioning to be applied to signals may be determined based on the determined effect on the RF signal(s) of being conducted though the interface 95 and/or the interface structure 100. For example, the amplification and/or conditioning to be applied to signals may be determined such that, after being conducted through the interface 95 and/or the interface structure 100 (e.g., after experiencing the determined effect on the RF signal(s) of being conducted though the interface 95 and/or the interface structure 100), the signal has one or more desired qualities.

FIG. 2B illustrates schematically manufacturing steps of disclosed electrically conductive coatings 110, in accordance with an example embodiment. In particular, method 250 corresponds to application of an electrically conductive coating 110 onto an interface 95 that is a solder joint. For example, the first conductive medium 90A may be a conductive pad of a PCB and the second conductive medium 90B may be a copper conductive wire. Starting at block 70, the second conductive medium 90B is soldered onto the first conductive medium 90A. Various soldering techniques and/or soldering material 85 may be used to solder the second conductive medium 90B to the first conductive medium 90A, in various embodiments, as appropriate for the application.

At block 252, an insulated mask is applied on areas of the substrate 80 that should remain uncoated by the electrically conductive coating. For example, a mask comprising an electrically insulating material may be patterned onto the substrate 80 to form and/or define unmasked areas where respective electrically conductive coatings 110 are to be applied, placed, and/or formed and masked areas where the conductive material of the electrically conductive coating 110 should not be applied.

At block 254, the electrically conductive coating 110 is formed on the unmasked areas. For example, the (broadband) electrically conductive material of the electrically conductive coating 110 may be applied to the unmasked areas using any of spraying, dipping, chemical and/or physical deposition, or other techniques. In some embodiments, the electrically conductive coating 110 is formed via 3D printing, which may be used after applying an insulated mask on the conductive areas to avoid shorts, or without applying an insulated mask.

At block 256, the mask is removed. For example, the mask may be removed from the substrate 80 using a technique appropriate for the material of the mask.

At block 71, the process continues by returning to the regular process flow. For example, the next step in fabricating the RF circuit of the circuit design may be performed.

FIGS. 3A-3C provide simulation results that indicate, according to some embodiments of the disclosure, the expected effect of disclosed electrically conductive coatings 110 by showing the relation between signal quality, insertion loss deviation and bit error rate per range of Zodd. The SI improvement as a result of disclosed electrically conductive coating 110 applied on interface 95 is due to the improved characteristics of the integrated conductive media of the interface structure 100. As a result, interface structure 100 has improved signal integrity at the interface 95, according to some embodiments of the disclosure. The illustrated simulation results are based on simulations of many different channels and RF frequency ranges, each including mismatched transmission line sections creating ripples in the frequency response of the channel, to estimate the effects on the SI in each case. Different channels include different values and combinations of load impedance and transmission line impedances to evaluate their effects on the signal integrity in the channel. The graphs presented in FIGS. 3A-3C summarize a characteristic sample of the results (for a transmission impedance across the interface 95 without the electrically conductive coating 110). Applied electrically conductive coatings 110 may be configured to increase the signal to noise ratio (SNR) in the channel (FIG. 3A), and to reduce the insertion losses (ILD-insertion loss deviation) of the channel (FIG. 3B), resulting in net decreases of the bit error rates (BER, FIG. 3C).

As indicated in FIGS. 3A-3C—the closer the load impedance (Zₒ) was to the nominal 50Ω, the more enhanced these effects were-resulting in larger reduction of the BER. Although the electrically conductive coating may cause higher signal attenuation, the electrically conductive coating reduces the noise (e.g., due mainly to reflection, thermal and perhaps other sources as minor contributors) and allows more efficient conditioning/amplification by the signal drivers. It is noted that the remaining BER is dominated by effects other than insertion loss (e.g., from the transmitter or receiver IC, such as signal distortions and random noise). It is further noted that SNR refers to the power of the signal with respect to the power of the noise in the signal, the latter being contributed by many different aspects such as various types of resistance (e.g., thermal noise, white noise) or by active components (1/f noise). Insertion loss (or S11 coefficient) refers to the amount of power of the signal that is reflected (and thus not transmitted). The disclosed electrically conductive coatings reduce the noise, and while the smoothed signal may have lower power, thanks to the better smoothening, the signal can be more efficiently amplified (in contrast to prior art without disclosed coatings, in which high insertion loss (bad S11) results in less signal power arriving at the load or the receiver and respectively results in a lower SNR at the receiver for the same amount of noise power).

In a complementary analysis it was found that for two differential pairs of transmission lines, performance was improved by reducing the impedance mismatch between them: increasing SNR, decreasing BER and decreasing insertion loss. Reducing the impedance mismatch may be achieved by applying electrically conductive coatings 110 over the interfaces 95 such that reflections at the interface 95 are reduced (fewer ripples were seen in the differential S-parameters).

These simulation results thus show the effectiveness of the disclosed interface structures 100 over a broad range of simulated channels, with corresponding load and line impedances and with respect to different signals.

In various embodiments, electrically conductive coatings 110 and interface structures 100 may be optimized to reduce BER at specific frequencies, such as 1-5 GHz, 25, 32 and 40 GHz, as well as 60 GHz, as non-limiting examples. For example, the coating properties may be optimized to match the product operating parameters (e.g., electrical current, frequencies, etc.), e.g., using empirical tests and/or theoretical considerations. For example, the electrically conductive coatings 110 may be designed for performance at particular operating parameters.

### Example Systems Including Interface Structures

In various embodiments, interface structures 100 are incorporated into various systems. For example, various interface structures 100 may be incorporated into datacenters, processing units, ICs, systems on and/or including PCBs, optical interconnects, and/or the like. Some example systems that may include interface structures 100 of various embodiments are now described.

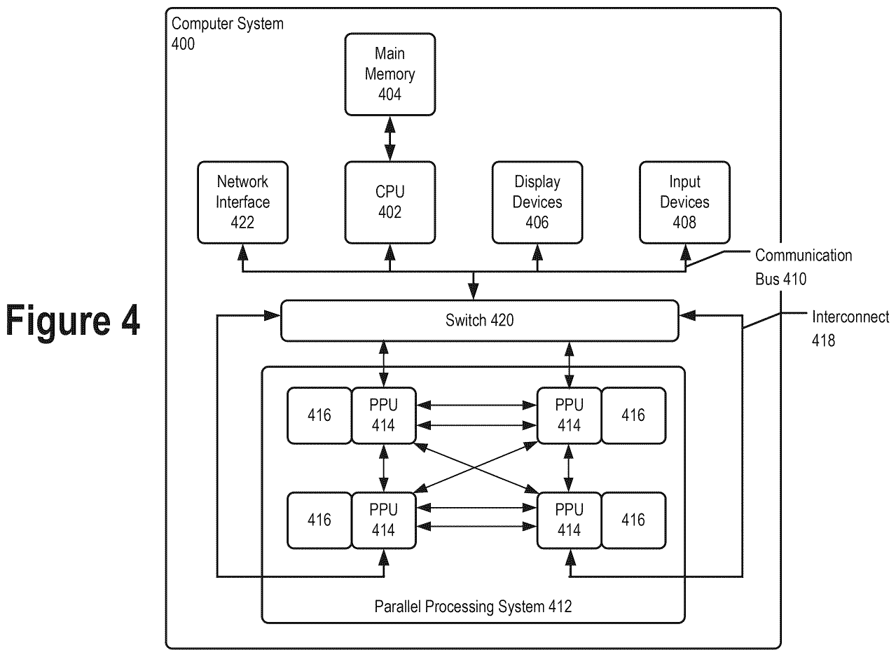

FIG. 4 illustrates a computer system 400, according to at least one embodiment. In at least one embodiment, computer system 400 is configured to implement various processes and methods described throughout this disclosure.

In at least one embodiment, computer system 400 comprises, without limitation, at least one central processing unit (“CPU”) 402 that is connected to a communication bus 410 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 400 includes, without limitation, a main memory 404 and control logic (e.g., implemented as hardware, software, or a combination thereof) and data are stored in main memory 404 which may take form of random access memory (“RAM”). In at least one embodiment, a network interface subsystem (“network interface”) 422 provides an interface to other computing devices and networks for receiving data from and transmitting data to other systems from computer system 400.

In at least one embodiment, computer system 400, in at least one embodiment, includes, without limitation, input devices 408, parallel processing system 412, and display devices 406 which can be implemented using a conventional cathode ray tube (“CRT”), liquid crystal display (“LCD”), light emitting diode (“LED”), plasma display, or other suitable display technologies. In at least one embodiment, user input is received from input devices 408 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 404 and/or secondary storage. Computer programs, if executed by one or more processors, enable system 400 to perform various functions in accordance with at least one embodiment. memory 404, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 402; parallel processing system 412; an integrated circuit capable of at least a portion of capabilities of both CPU 402; parallel processing system 412; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 400 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 412 includes, without limitation, a plurality of parallel processing units (“PPUs”) 414 and associated memories 416. In at least one embodiment, PPUs 414 are connected to a host processor or other peripheral devices via an interconnect 418 and a switch 420 or multiplexer. In at least one embodiment, parallel processing system 412 distributes computational tasks across PPUs 414 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 414, although such shared memory may incur performance penalties relative to use of local memory and registers resident to a PPU 414. In at least one embodiment, operation of PPUs 414 is synchronized through use of a command such as_syncthreads( ), wherein all threads in a block (e.g., executed across multiple PPUs 414) to reach a certain point of execution of code before proceeding.

The switches within each layer (e.g., edge layer, aggregation layer, core layer) may be 1U switches, where “1U” refers to the industry-standard size for rack-mounted switches and servers. The switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch.

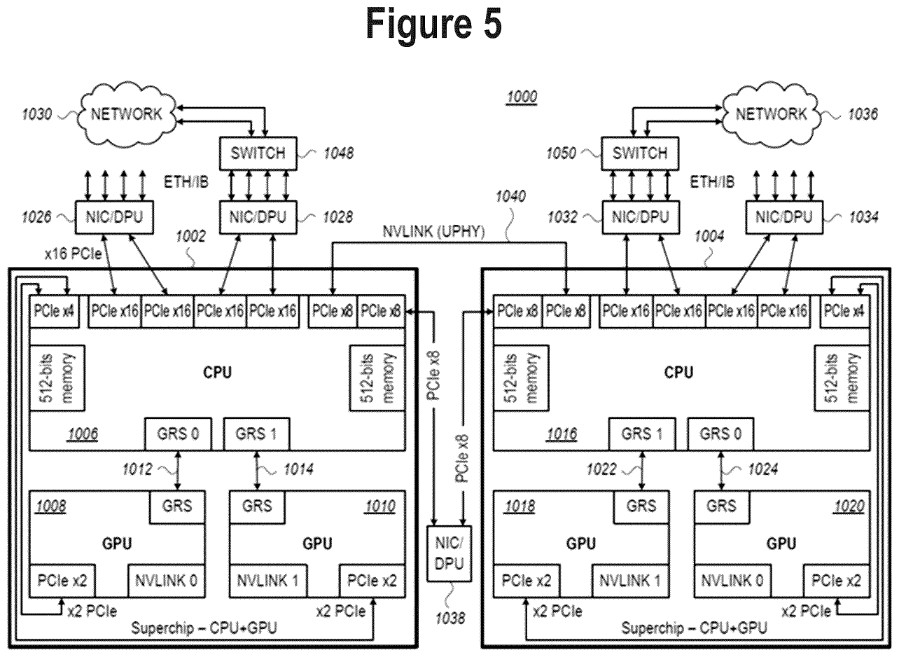

FIG. 5 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 5 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 5, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

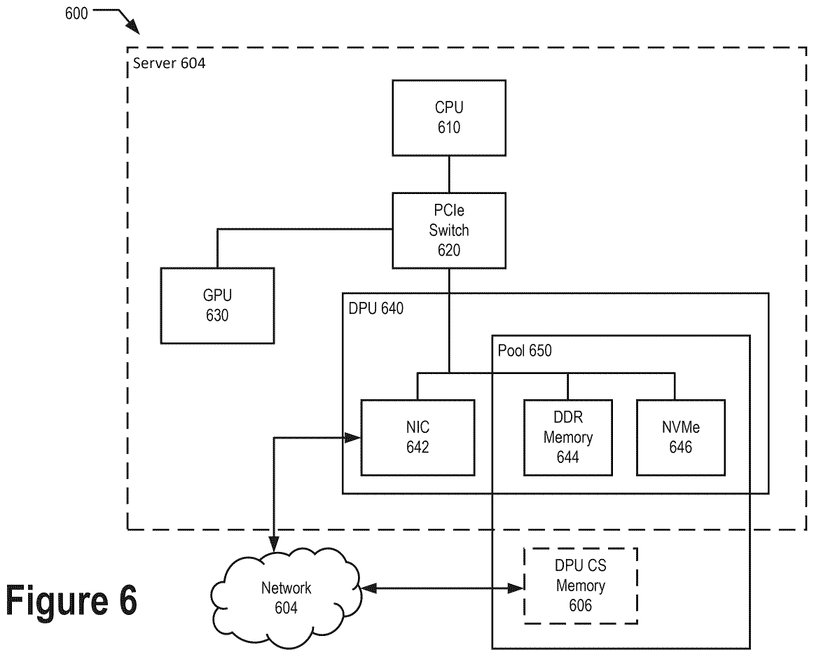

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 6, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 5 may comprise, for example, Nvidia Quantum-2 switches. The NICs/DPUs in the figure may comprise, for example, Nvidia Bluefield DPUs.

In various embodiments, any of the network devices of system 1000, e.g., any of NICs/DPUs 1026, 1028, 1032, 1034, and 1038, and/or any of switches 1048 and 1050, may include electrical components in accordance with various embodiments.

FIG. 6 illustrates an example computing environment 600 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 600 may include a server 602 which may be used to perform HPC workloads, such as AI training or machine learning model training. In an embodiment, the server 602 may be an application instance or a compute node. The server 602 may include a CPU 610 associated with a switch 620, such as a peripheral component interconnect express (PCIe) switch, which may control at least some data transmission over communication paths interconnecting various components. In an embodiment, the CPU 610 may include a root complex processor.

The PCIe switch 620 may also be associated with a GPU 630 and a DPU 640, and may transmit data between at least some of the CPU 610, the GPU 630, the DPU 640, and other components. In an embodiment, the PCIe switch 620 may be associated with more than one GPU or more than one DPU. In another embodiment, the PCIe switch 620 may be located within the DPU 640. The PCIe switch 620 may manage the transfer of at least some data between the CPU 610, the GPU 630, and the DPU 640. In another embodiment, the number of GPUs associated with the PCIe switch 620 may be equal to the number of DPUs associated with the PCIe switch 620. In at least one embodiment, the server 602 may include, without limitation, any number of the CPUs 610, the PCIe switches 620, the GPUs 630, and/or the DPUs 640, in any combination. For example, in at least one embodiment, server 602 could include eight, sixteen, thirty-two, and/or more GPUs 630. In at least one embodiment, communication paths interconnecting various components, including but not limited to the CPU 610, the PCIe switch 620, the GPU 630, and the DPU 640, in FIG. 6 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 640 may include a network interface controller (NIC) 642, a DDR memory 644, and a non-volatile memory express (NVMe) device 646. The NIC 642 may be able to interface with a network 604, which may also interface with additional NVMe devices available to the DPU 640, such as over fabric. In an embodiment, the DPU 640 may not include the NVMe device 646. In another embodiment, the NVMe device 646 may be located on the server 602 and not on the DPU 640. In yet another embodiment, the computing environment 600 may include more than one of the NVMe device 646, such as a first NVMe device in the DPU 640 and a second first NVMe device on the server 602 an associated directly with the PCIe switch 620. In an embodiment, the DPU 640 may not include the DDR memory 644 and may include a computational storage services (CSS) in place of, or in addition to, the DDR memory 644. For example, computing environment 600 may include DPU computational storage (CS) memory 606 available to the DPU 640 as part of the CSS. The network 604 may be able to interface with the DPU CS memory 606 through the NIC 642, according to any suitable interface protocol, such as remote direct memory access (RDMA) over Ethernet, InfiniBand, Fiber Channel, etc.

The total memory of the computing environment 600 available for data storage may be expanded through the use of the DPU 640 on nodes of the system. The DPU 640 may have access to a pool 650 of memory already available to the server 602, such as double data rate (DDR) memory, on-board NVMe devices, NVMe devices over fabric, and CS. The pool 650 of memory may include at least one of the DDR memory 644, NVMe 646, and the DPU CS memory 606. The DPU 640 may also be able to access the available memory of other DPUs as part of the pool 650, and other DPUs may be able to access the available memory of DPU 640, such as the pool 650. This available memory can be accessed and utilized for data storage, without the addition of compute resources, such as compute nodes, which would be required using other solutions. The available pool 650 accessible to the DPU 640 may be provisioned for the server 602 to expand the total memory available for data storage, such as to reduce the data storage load on the CPU 610 or the GPU 630, which can instead increase the utilization of their memory for processing. For example, during training of an AI, the model states, residual states, activation functions, and checkpoints can be stored, or offloaded, on the pool 650 accessible to the DPU 640.

In the above description, an embodiment is an example or implementation of the disclosure. The various appearances of “one embodiment,” “an embodiment,” “certain embodiments,” or “some embodiments” do not necessarily all refer to the same embodiments. Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Certain embodiments of the disclosure may include features from different embodiments disclosed above, and certain embodiments may incorporate elements from other embodiments disclosed above. The disclosure of elements of the disclosure in the context of a specific embodiment is not to be taken as limiting their use in the specific embodiment alone. Furthermore, it is to be understood that the disclosure can be carried out or practiced in various ways and that the disclosure can be implemented in certain embodiments other than the ones outlined in the description above.

The disclosure is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the disclosure belongs, unless otherwise defined. While the disclosure has been described with respect to a limited number of embodiments, these should not be construed as limitations on the scope of the disclosure, but rather as exemplifications of some of the preferred embodiments. Other possible variations, modifications, and applications are also within the scope of the disclosure. Accordingly, the scope of the disclosure should not be limited by what has thus far been described, but by the appended claims and their legal equivalents.

What is claimed is:

1. An interface structure comprising:
an interface between a first conductive medium and a second conductive medium; and
an electrically conductive coating in electrical communication with both the first conductive medium and the second conductive medium across the interface.

2. The interface structure of claim 1, wherein the first conductive medium and the second conductive medium have different characteristic impedances.

3. The interface structure of claim 1, wherein the electrically conductive coating is configured to create a continuous conductive surface over the interface.

4. The interface structure of claim 1, wherein the electrically conductive coating is configured to reduce an impedance mismatch across the interface between the first conductive medium and the second conductive medium.

5. The interface structure of claim 1, wherein the electrically conductive coating comprises graphene.

6. The interface structure of claim 1, wherein the electrically conductive coating is between one atomic layer and 100 μm thick.

7. The interface structure of claim 1, wherein the interface includes a mechanical interface or a solder joint.

8. The interface structure of claim 1, wherein the interface includes at least one of: a conductive wire, a flyover cable, a conductive pad of a printed circuit board (PCB), a conductive pad on a die, a wire bond, a solder bump connection, a via interface, or an interface between vias to a ball grid array (BGA).

9. The interface structure of claim 1, wherein the interface is a solder joint and includes a soldering material in additional to the first conductive medium and the second conductive medium and the electrically conductive coating is in electrical communication with each of the first conductive medium, the second conductive medium, and the soldering material.

10. A method comprising:
applying an electrically conductive coating to an interface between a first conductive medium and a second conductive medium such that the electrically conductive coating is in electrical communication with both the first conductive medium and the second conductive medium across the interface.

11. The method of claim 10, wherein applying the electrically conductive coating to the interface comprises creating a continuous conductive surface across the interface.

12. The method of claim 10, wherein the first conductive medium and the second conductive medium have different characteristic impedances.

13. The method of claim 10, wherein the electrically conductive coating is configured to reduce an impedance mismatch across the interface between the first conductive medium and the second conductive medium.

14. The method of claim 10, wherein the interface comprises a solder joint or a mechanical connection between the first conductive medium and the second conductive medium.

15. The method of claim 10, wherein applying the electrically conductive coating to the interface comprises forming a two-dimensional (2D) or three-dimensional (3D) coating made of a conductive material that reduces signal reflections across the interface.

16. The method of claim 10, wherein the applying of the electrically conductive coating to the interface is carried out by at least one of: spraying, sputtering, dipping, brushing, depositing, dispensing, printing, or application through a mask.

17. The method of claim 10, further comprising:
configuring the electrically conductive coating to improve signal integrity by attenuating signals passing through the interface.

18. The method of claim 17, further comprising:
determining an amplification or conditioning to be applied to the signals to be conducted across the interface based at least in part on attenuation of the signals passing through the interface by the electrically conductive coating.

19. The method of claim 10, further comprising:
identifying one or more interfaces in a circuit design that are prone to SI reduction, wherein the interface between the first conductive medium and the second conductive medium is one of the one or more interfaces.

20. The method of claim 19, wherein respective electrically conductive coatings are applied to each of the one or more interfaces such that the electrically conductive coatings do not short-circuit one or more circuits comprising the one or more interfaces.
